(19) United States
(12) Patent Application Publication
(10) Pub. No.: US 2018/0020144 A1
(43) Pub. Date: Jan. 18, 2018

(54) SKIN ANALYZER

(71) Applicant: LARGAN PRECISION CO., LTD., Taichung City (TW)

(72) Inventors: Chen-Yi Huang, Taichung City (TW); Yi-Chen Hsieh, Taichung City (TW); Yu-Cheng Ke, Taichung City (TW); Tsung-Yung Hung, Taichung City (TW)

(21) Appl. No.: 15/297,223

(22) Filed: Oct. 19, 2016

(30) Foreign Application Priority Data
Jul. 14, 2016 (TW) 105210610

(51) Int. Cl. H04N 5/235; H04N 5/225; H04N 5/232; G06K 9/00

(52) U.S. Cl. CPC H04N 5/2352; H04N 5/2354; G06K 9/00255; H04N 5/2254; H04N 5/23293

(57) ABSTRACT

A skin analyzer includes a base, an optical imaging system, a flash module, a circuit module, a computing module and a display module. The optical imaging system is disposed on the base for capturing an image of an imaging area. The flash module is disposed on at least one side of the optical imaging system. The circuit module is disposed in the base and electrically connected with the optical imaging system and the flash module. The computing module has a signal transmitting connection with the circuit module. The display module has a signal transmitting connection with the computing module.

### RELATED APPLICATIONS

This application claims priority to Taiwan Application Serial Number 105210610, filed Jul. 14, 2016, which is herein incorporated by reference.

### BACKGROUND

### Technical Field

The present disclosure relates to a skin analyzer. More particularly, the present disclosure relates to a skin analyzer for suppressing image signal disturbance from overlapping signals.

### Description of Related Art

It's our human nature to appreciate beauty. No matter in aesthetics or from a physical health point of view, everyone wants to have an attractive appearance. The condition of our facial skin is a decisive factor for judging a person's attractiveness. Therefore, an assessment of the facial skin condition of a subject becomes very important now. Conventionally, in the field of cosmetic treatments, the evaluation of the skin condition is done subjectively by naked eyes of a medical practitioner with his or her past experiences. The accuracy of the evaluation is oftentimes debatable and cannot reflect the whole picture of the subject's condition.

The imaging technology is developing vigorously in recent years and thus an image of the facial skin of a subject can be captured by a high resolution camera. Then, the skin image data can be digitized by processing the image through an image recognition algorithm for an objective diagnosis. For example, the image recognition algorithm can be an independent component analysis (ICA). The independent component analysis isolates elements like hemoglobin and melanin of the facial skin from the subject into a first independent component and a second independent component, respectively, for determining the current skin condition of the subject. In short, the independent component analysis first captures the facial skin image of the subject with the high resolution camera. Original image data of red band (R), green band (G) and blue band (B) will be processed by a conversion equation so as to be converted into three independent components. The first independent component is used for determining a distribution of the hemoglobin, and the second independent component is used for determining a distribution of the melanin. However, there are overlapping signal occurrences between different band signals in the original RGB data. One is between the blue band and the green band. The other is between the green band and the red band. Thus, each of the converted independent components cannot effectively present original features of the facial skin of the subject. That is, an accurate image cannot be provided after the conversion.

Accordingly, a skin analyzer, which can improve the quality of the converted image, is necessary in the market.

### SUMMARY

According to one aspect of the present disclosure, a skin analyzer includes a base, an optical imaging system, at least a flash module, a circuit module, a computing module and a display module. The optical imaging system is disposed on the base facing toward an imaging area. Furthermore, the optical imaging system includes a band-stop filter set, an imaging polarizer and an imaging module. The flash module is disposed on at least one side of the optical imaging system and includes a flash polarizer, a flash lamp and a flash activation circuit. The circuit module is disposed in the base and connected electrically with the optical imaging system and the flash module. Furthermore, the circuit module includes a power control circuit, a data transmission circuit and a signal synchronization circuit. The computing module has a signal transmitting connection with the circuit module. The display module has a signal transmitting connection with the computing module.

According to another aspect of the present disclosure, a skin analyzer includes a base, an optical imaging system, at least a flash module, a circuit module, a computing module and a display module. The optical imaging system is disposed on the base and includes a band-pass filter, an imaging polarizer and an imaging module. The flash module is disposed on at least one side of the optical imaging system. Furthermore, the flash module includes a flash polarizer, a flash lamp and a flash activation circuit. The circuit module is disposed in the base and connected electrically with the optical imaging system and the flash module. Furthermore, the circuit module includes a power control circuit, a data transmission circuit and a signal synchronization circuit. The computing module and the display module are both connected electrically to the circuit module.

According to yet another aspect of the present disclosure, a skin analyzer includes a base, an optical imaging system, at least a flash module, a circuit module, a computing module and a display module. The optical imaging system is disposed on the base facing toward an imaging area. Furthermore, the optical imaging system includes an imaging module. The flash module is disposed on at least one side of the optical imaging system and includes a flash lamp and a flash activation circuit. The circuit module is disposed in the base and connected electrically with the optical imaging system and the flash module. Furthermore, the circuit module includes a power control circuit, a data transmission circuit and a signal synchronization circuit. The computing module has a signal transmitting connection with the circuit module. The display module has a signal transmitting connection with the computing module and is a portable device disposed on the base.

### BRIEF DESCRIPTION OF THE DRAWINGS

The present disclosure can be further understood by reading the following detailed description of the embodiment, with reference made to the accompanying drawings as follows:

FIG. 1 is a schematic view of a skin analyzer according to an embodiment of the present disclosure;

FIG. 2A is a schematic view of an optical imaging system of FIG. 1;

FIG. 2B is another schematic view of the optical imaging system of FIG. 1;

FIG. 3A is a front view of a skin analyzer according to a first example of the present disclosure;

FIG. 3B is a three dimensional view of the skin analyzer according to the first example of the present disclosure;

FIG. 3C is a right side view of the skin analyzer according to the first example of the present disclosure;

FIG. 3D is a three dimensional view of the skin analyzer of FIG. 3B without the configuration of a portable device;

FIG. 3E is a rear side view of the skin analyzer according to the first example of the present disclosure;

FIG. 4A is a drawing showing response curves of an image sensor of a skin analyzer without the configuration of a band-stop filter set;

FIG. 4B is a drawing showing a transmission data of a first band-stop filter of the skin analyzer according to the first example of the present disclosure;

FIG. 4C is a drawing showing a transmission data of a second band-stop filter of the skin analyzer according to the first example of the present disclosure;

FIG. 4D is a drawing showing response curves of an image sensor of the skin analyzer according to the first example of the present disclosure;

FIG. 5A is a three dimensional view of a skin analyzer according to a second example of the present disclosure;

FIG. 5B is a three dimensional view of the skin analyzer of FIG. 5A without the configuration of a portable device;

FIG. 5C is a schematic view of a flash module in a folded position of the skin analyzer according to the second example of the present disclosure;

FIG. 6 is a structural schematic view of the flash module of the skin analyzer according to the second example of the present disclosure;

FIG. 7 is schematic view showing an operation status of the skin analyzer according to the first example of the present disclosure; and

FIG. 8 is a flow chart of an image analysis process of the skin analyzer according to the first example of the present disclosure.

### DETAILED DESCRIPTION

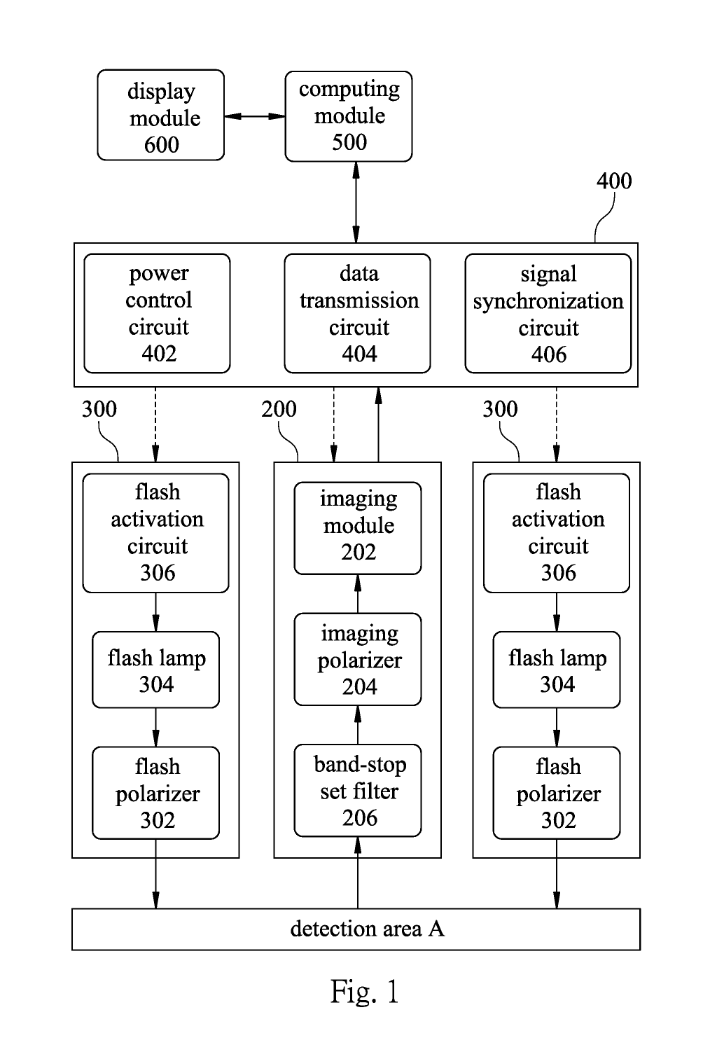

Please refer to FIG. 1. FIG. 1 is a schematic view of a skin analyzer according to an embodiment of the present disclosure. The present disclosure provides a skin analyzer for detecting a skin condition of an imaging area A of a subject (not shown). The skin analyzer includes a base (not shown), an optical imaging system 200, at least a flash module 300, a circuit module 400, a computing module 500 and a display module 600.

Although it is not shown by the figure, the base is provided for supporting other components of the skin analyzer. The base of the skin analyzer can be a hollow case and made of a plastic material.

The optical imaging system 200 is disposed on the base facing toward the imaging area and includes an imaging module 202, an imaging polarizer 204 and a band-stop filter set 206.

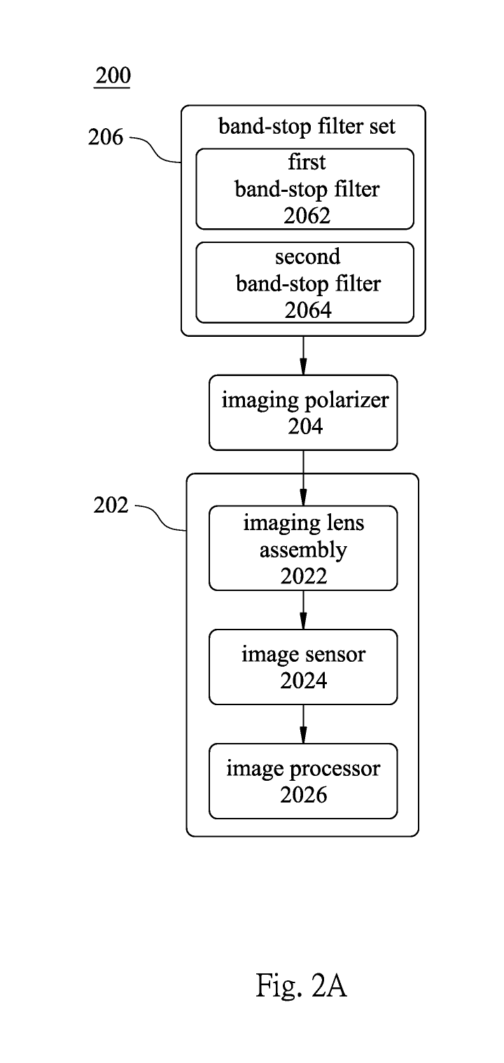

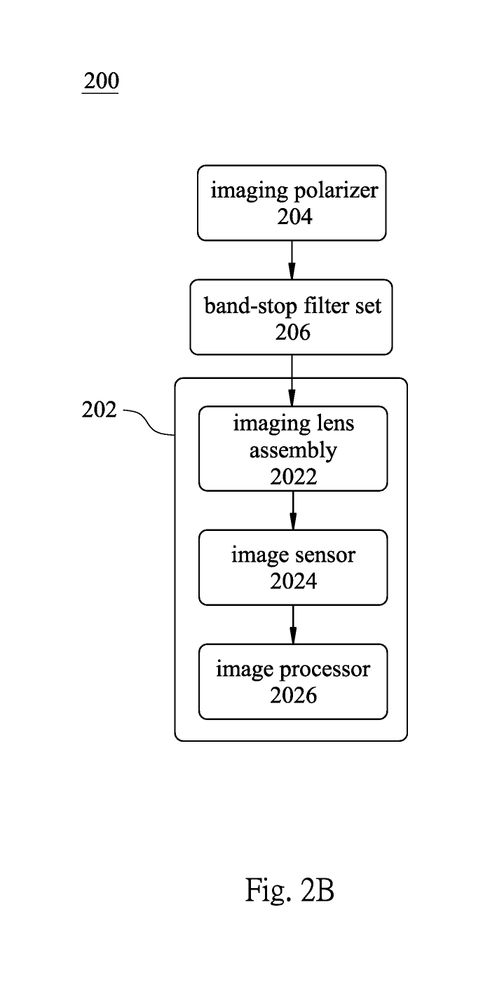

Please refer to FIGS. 2A and 2B. FIG. 2A is a schematic view of the optical imaging system 200 of FIG. 1. FIG. 2B is another schematic view of the optical imaging system 200 of FIG. 1. As shown in FIG. 2A, the imaging module 202 includes an imaging lens assembly 2022, an image sensor 2024 and an image processor 2026. The imaging lens assembly 2022 includes a plurality of lens elements. The image sensor 2024 can be a charge-coupled device (CCD) or a complementary metal-oxide-semiconductor (CMOS). The image processor 2026 can be a dedicated graphics card or an integrated graphics processor. The image processor 2026 is mainly provided for processing the image retrieved from the optical imaging system 200, and transmitting image information to the computing module 500 via the circuit module 400.

Subsequently, the imaging polarizer 204 is located between the imaging module 202 and the imaging area A. The imaging polarizer 204 can be a linear polarizer, a circular polarizer or an elliptical polarizer.

The band-stop filter set 206 is also located between the imaging module 202 and the imaging area A. Additionally, the imaging polarizer 204 can be located between the band-stop filter set 206 and the imaging module 202 as shown in FIG. 2A. The band-stop filter set 206 also can be located between the imaging polarizer 204 and the imaging module 202 as shown in FIG. 2B.

Furthermore, the band-stop filter set 206 can include one multi-band-stop filter or a plurality of single-band-stop filters. In particular, the band-stop filter set 206 includes three or less single-band-stop filters. Furthermore, the band-stop filter set 206 in the present disclosure is provided for suppressing the overlapping signals of the B-G band and the G-R band. Thus, the band-stop filter set 206 can include a first band-stop filter 2062 and a second band-stop filter 2064 as shown in FIG. 2A. The conditions of the abovementioned filters will be further described in the following embodiments. In addition, the single-band-stop filter can be a notch filter.

Please refer to FIG. 1. The flash module 300 is disposed on at least one side of the optical imaging system 200. The flash module 300 includes a flash polarizer 302, a flash lamp 304 and a flash activation circuit 306. The flash polarizer 302 is located between the flash lamp 304 and the imaging area A, and the flash polarizer 302 can be a linear polarizer, a circular polarizer or an elliptical polarizer. The flash lamp 304 can be a xenon flash lamp or a light-emitting diode (LED). The flash activation circuit 306 can be further divided into a capacitive charging circuit and a signal triggering circuit. When the signal triggering circuit is activated, the capacitive charging circuit starts discharging to allow the flash lamp 304 to perform an ambient light compensation. Therefore, the quality of the image captured by the optical imaging system 200 will be enhanced.

The circuit module 400 can be disposed in the base and connected electrically with the optical imaging system 200 and the flash module 300. The circuit module 400 can include a power control circuit 402, a data transmission circuit 404 and a signal synchronization circuit 406. The power control circuit 402 is provided for controlling circuits and power sources, which may be disposed in the abovementioned elements. The data transmission circuit 404 is provided for transmitting image information, which is retrieved by the optical imaging system 200 and transferred to the computing module 500. The signal synchronization circuit 406 is provided for controlling the optical imaging system 200 and the flash module 300 synchronously. In addition, the data transmission circuit 404 includes a wireless transmission module or a wired transmission module. The wireless transmission module can be a Bluetooth wireless transmission module or an infrared wireless transmission module.

The computing module 500 has a signal transmitting connection with the circuit module 400 for receiving image information through the data transmission circuit 404 of the circuit module 400. The computing module 500 will further compute image information to output a detection result of the skin condition. In particular, the computing module 500 is provided to check image information captured by the optical Imaging system 200. Furthermore, the computing module 500 analyzes and computes the abovementioned information to produce the detection result of the skin condition. Then, the image and the detection result are shown in the display module 600. The computing module 500 can be any modules capable of completing the abovementioned operation, such as a microprocessor, a smart mobile device, a personal computer or a server.

The display module 600 has a transmitting connection with the computing module 500 for receiving and displaying the image and the detection result of the skin condition. Furthermore, the display module 600 can display interactive information of a user interface (not shown) to be operated by the subject or the medical practitioner. Then, the display module 600 can display the image and the detection information of the skin condition from the computing module 500. Thus, the display module 600 can be a thin film transistor liquid crystal display (TFT-LCD), an active-matrix organic light-emitting diode (AMOLED) or a flexible display.

It is noted that the computing module 500 and the display module 600 can be disposed in different devices in the present disclosure. For example, the computing module 500 and the display module 600 can be another microprocessor, portable device or personal computer. The transmission and reception of the image information between the circuit module 400 and each of the computing module 500 and the display module 600 can be completed through the data transmission circuit 404, which utilizes wireless transmission technologies. However, the computing module 500 and the display module 600 also can be integrated into a portable device or a personal computer. Moreover, the computing module 500 and the display module 600 can be built in the base and cooperated with a display for showing the image and the detection result of the skin condition.

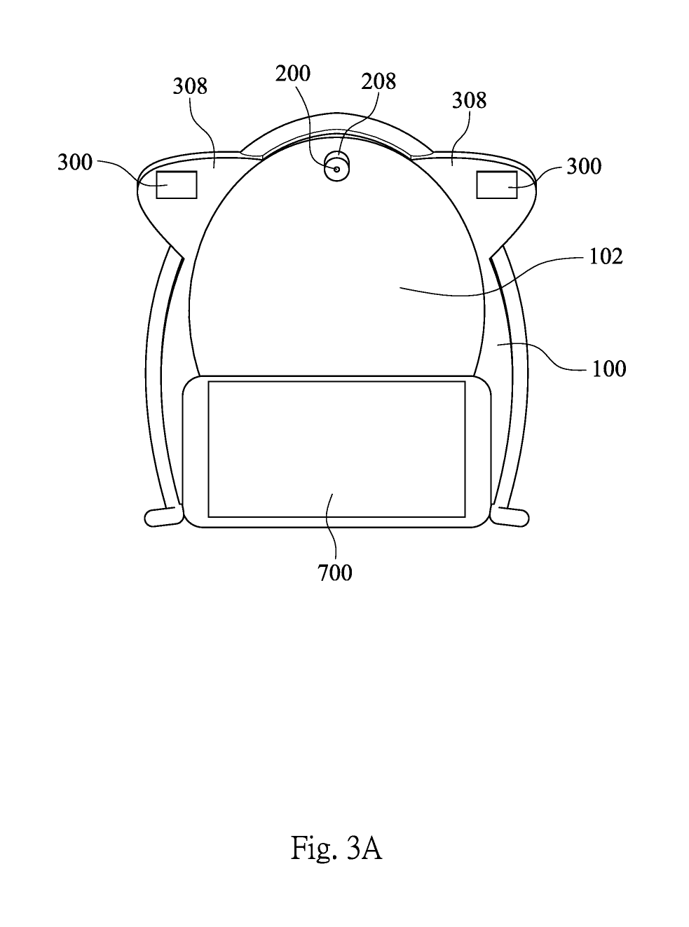

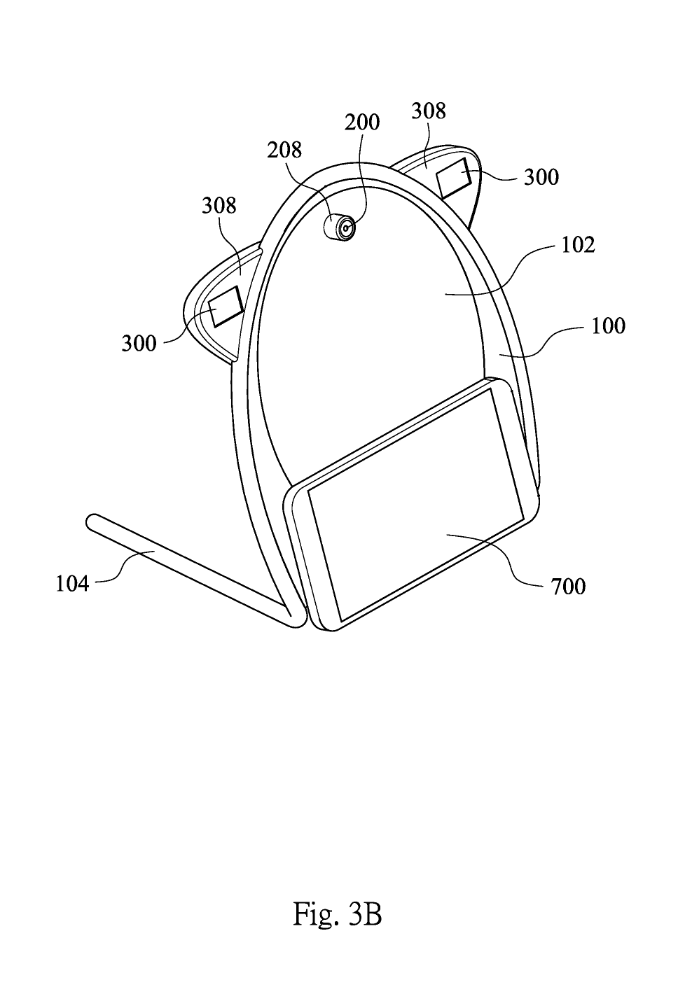

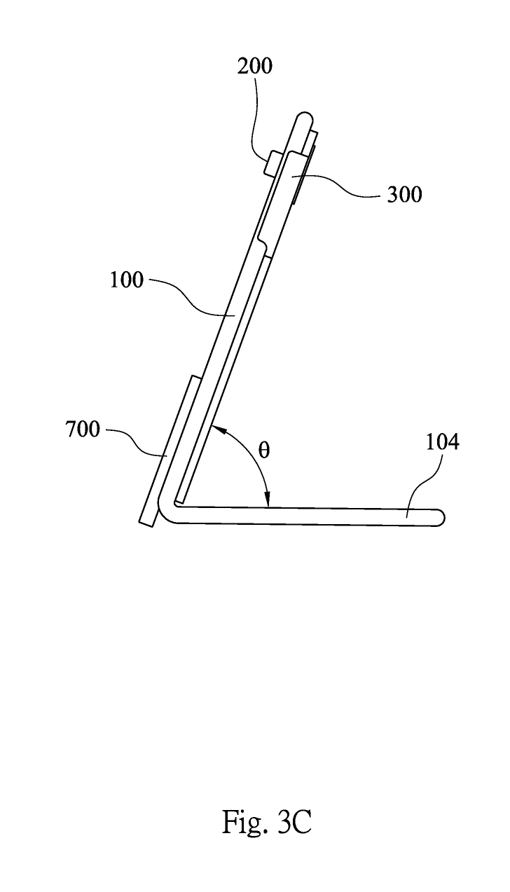

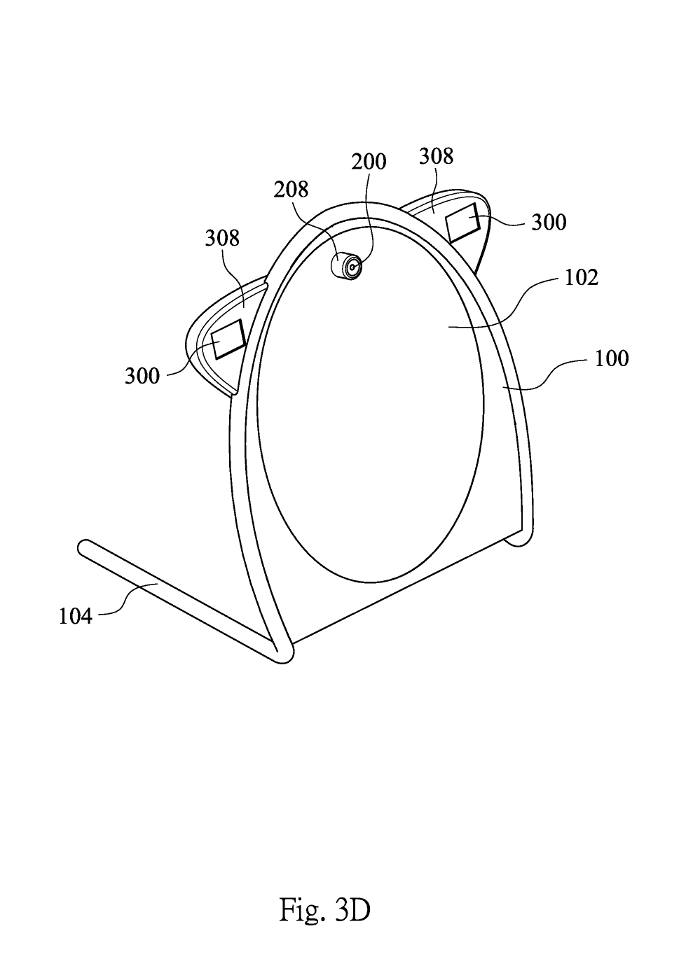

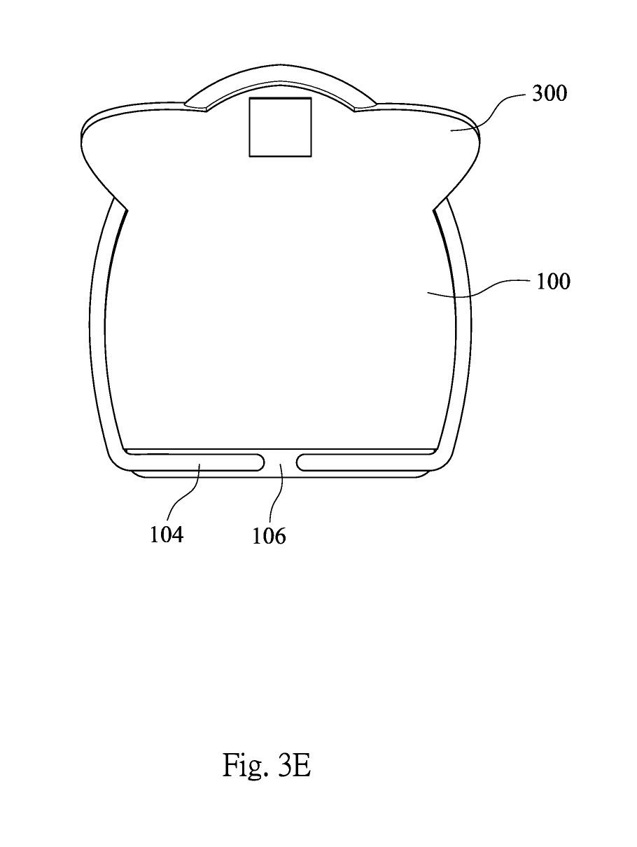

Please refer to FIGS. 3A, 3B, 3C, 3D and 3E. FIG. 3A is a front view of a skin analyzer according to a first example of the present disclosure. FIG. 3B is a three dimensional view of the skin analyzer according to the first example of the present disclosure. FIG. 3C is a right side view of the skin analyzer according to the first example of the present disclosure. FIG. 3D is a three dimensional view of the skin analyzer of FIG. 3B without the configuration of a portable device. FIG. 3E is a rear side view of the skin analyzer according to the first example of the present disclosure. The structure of the skin analyzer according to the first example of the present disclosure is shown in FIG. 1 and FIG. 2A. That is, the skin analyzer of the first example includes a base 100, an optical imaging system 200, at least a flash module 300, a circuit module 400, a computing module 500 and a display module 600. It is noted that the computing module 500 and the display module 600 of the skin analyzer of the first example are built in the portable device 700.

As shown in FIG. 3A and FIG. 3B, the base 100 of the skin analyzer of the first example can be a case with a semi-circle shape. The base 100 has a receiving space (not shown) for other parts if necessary. In addition, the base 100 further includes a mirror portion 102. The mirror portion 102 is disposed at one side of the base 100 while facing the subject. The mirror portion 102 can be utilized to ensure the subject is positioned within the field of view of the optical imaging system 200. As shown in FIG. 3C, the base 100 has a slim shaped structure and the base 100 can further include a stand 104. The stand 104 is connected to a lower portion of the base 100 for supporting the base 100 against a surface plane and has an angle θ with the surface plane. In addition, the stand 104 is rotatable and connected to the base 100 so that the angle θ can be adjusted. Thus, the portable device 700 can be placed against the mirror portion 102 and is held in place by friction thereof.

More particularly, the portable device 700 can be detached from the base 100 when the skin analyzer is not in the use, as shown in FIG. 3D and FIG. 3E. Furthermore, the base 100 further includes a first receiving groove 106. The stand 104 can be rotated and folded into the first receiving groove 106 for compactness of the skin analyzer.

In addition, the optical imaging system 200 is disposed at an upper portion of the base 100 and includes a first housing 208 for concealing the abovementioned elements. The first housing 208 is further coupled with the base 100 to prevent elements of the optical imaging system 200 from being affected by the external environmental factors while operating.

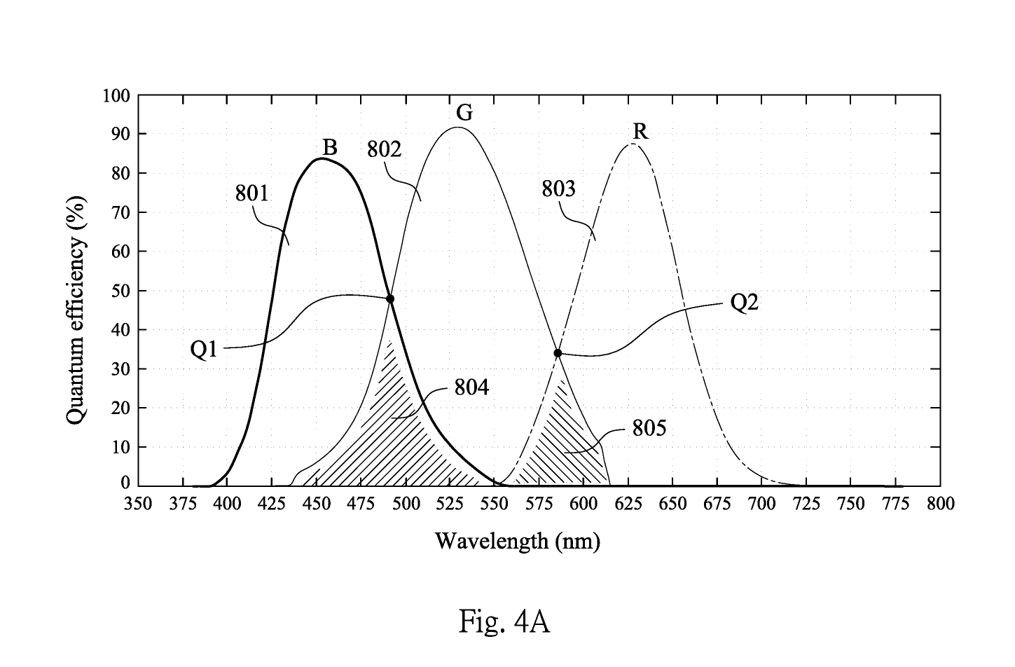

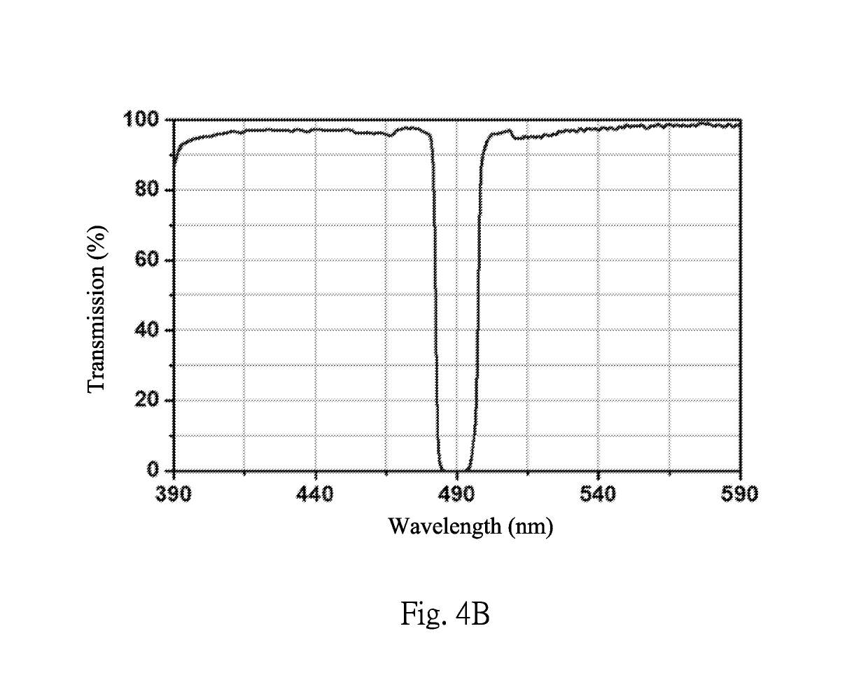

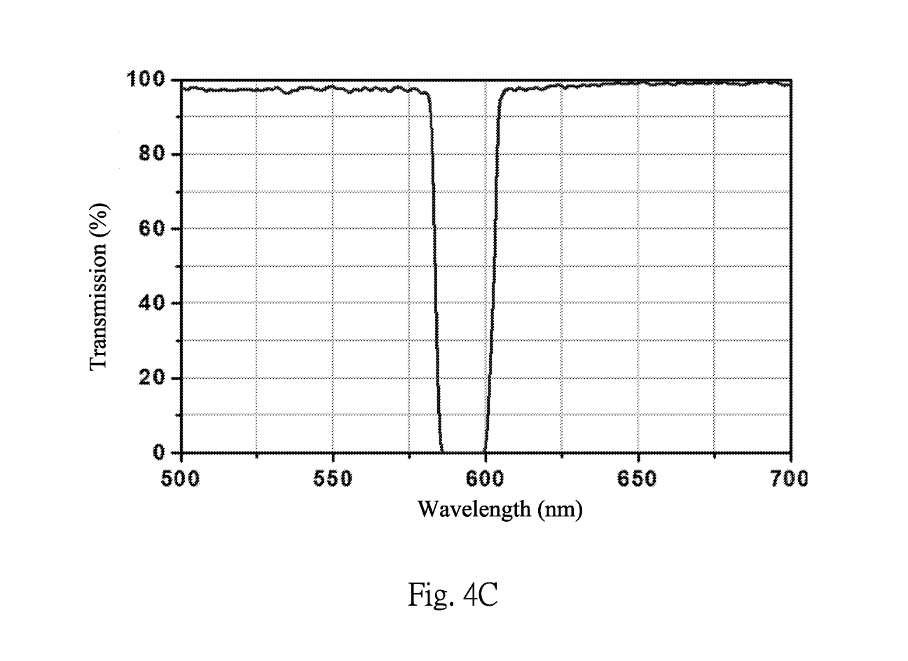

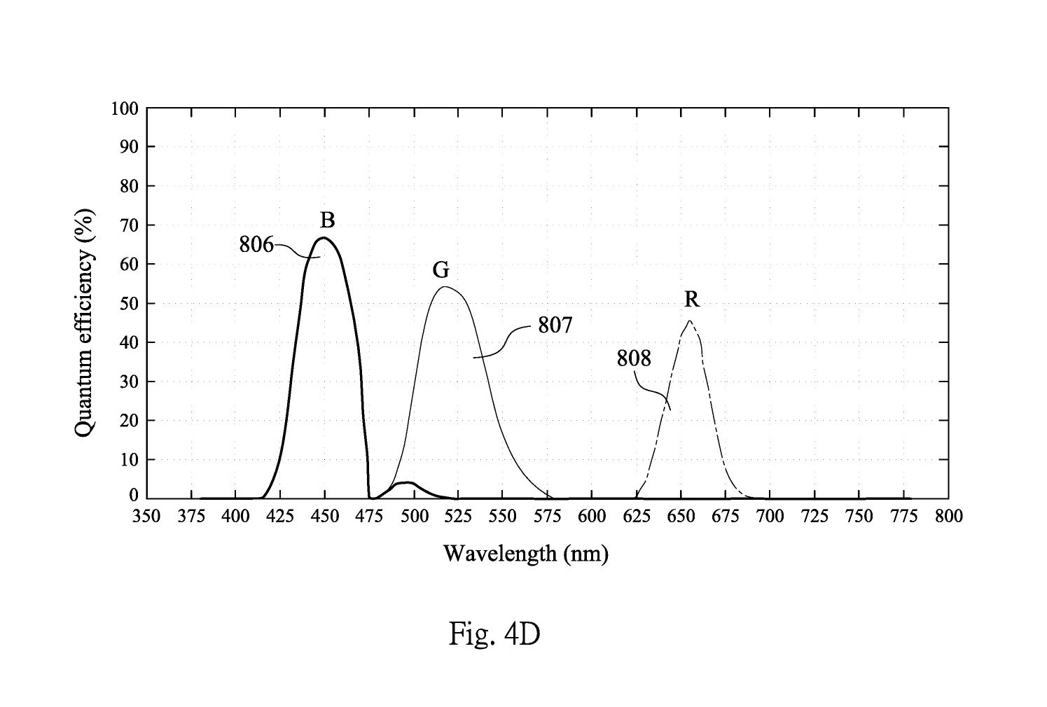

Further referring to FIG. 4A, a drawing shows response curves of an image sensor of a skin analyzer without the configuration of a band-stop filter set. As shown in FIG. 4A, there are two overlapping signals 804 and 805 without the configuration of the band-stop filter set. The overlapping signal 804 occurs between a blue band 801 and a green band 802, and the overlapping signal 805 occurs between a green band 802 and a red band 803. Thus, each of the converted independent components cannot present original features of the facial skin of the subject effectively. The data of FIG. 4A is listed as Table 1:

TABLE 1

| # | Center Wavelength (nm) | Full Width at Half Maximum (nm) |
|---|---|---|
| 801 | 450 +/− 2 | +/−50 |
| 802 | 530 +/− 2 | +/−50 |
| 803 | 625 +/− 2 | +/−50 |
| 804 | 490 +/− 2 | +/−25 |
| 805 | 590 +/− 2 | +/−25 |

In order to suppress the overlapping signals of the B-G band and the G-R band, the band-stop filter set 206 of the first example can include a first band-stop filter 2062 and a second band-stop filter 2064 as shown in FIG. 2A. Furthermore, a center wavelength of a band-stop of the first band-stop filter 2062 can be set up at an intersection Q1 of the blue band and the green band (B-G band) as shown in FIG. 4A. Moreover, a center wavelength of a band-stop of the second band-stop filter 2064 can be set up at an intersection Q2 of the green band and the red band (G-R band).

The first band-stop filter 2062 is a blue-green filter, and the second band-stop filter is a green-red filter. When an upper limit wavelength of a band-stop of the first band-stop filter 2062 is WL1 and a lower limit wavelength of a band-stop of the second band-stop filter 2064 is WL2, the following condition is satisfied: 70 nm<WL2−WL1<100 nm.

Additionally, the rejected band of the first band-stop filter 2062 is ranging from 471 nm to 504 nm. Furthermore, the rejected band has a center wavelength of 488 nm, with a full width at half maximum of 15 nm and an error within 2 nm in positive or in negative. Further referring to FIG. 4B, a drawing shows a transmission data of the first band-stop filter 2062 of the skin analyzer according to the first example of the present disclosure. The transmission of the first band-stop filter 2062 between 482 nm and 498 nm is less than 50%. The rejected band of the second band-stop filter 2064 is ranged from 572 nm to 616 nm. Moreover, the rejected band has a center wavelength of 594 nm, a full width at half maximum of 23 nm and an error within 2 nm in positive or in negative. As shown in FIG. 4C, a drawing shows a transmission data of the second band-stop filter 2064 of the skin analyzer according to the first example of the present disclosure. The transmission of the second band-stop filter 2064 between 583 nm and 603 nm is less than 50%.

Please refer to FIG. 4D. FIG. 4D is a drawing showing response curves of an image sensor of the skin analyzer according to the first example of the present disclosure. The data of FIG. 4D is listed as Table 2:

TABLE 2

| # | Center Wavelength (nm) | Full Width at Half Maximum (nm) |
|---|---|---|
| 806 | 450 +/− 2 | +/−25 |
| 807 | 520 +/− 2 | +/−25 |
| 808 | 660 +/− 2 | +/−25 |

As shown in FIG. 4D and Table 2, the overlapping signals between the blue band 806 and the green band 807, and the overlapping signals between the green band 807 and the red band 808 are both improved with the band-stop filter set. In addition, a peak quantum efficiency of a red band of the image sensor is less than a peak quantum efficiency of a green band or a blue band of the image sensor. Furthermore, a full width at half maximum of the band-stop filter set is less than 40 nm.

In addition, a band-pass filter also can be utilized for suppressing the overlapping signals of the B-G band and the G-R band. In particular, a filter with passing bands of 400 nm˜471 nm, 504 nm˜572 nm and 616 nm˜700 nm can be utilized as the band-pass filter as mentioned above.

The flash module 300 also includes a second housing 308. As shown in FIG. 3A, the abovementioned elements of the flash module 300 can be covered by the second housing 308. The second housing 308 is further coupled with the base 100 to prevent elements of the flash module 300 from being affected by the external environmental factors while operating.

In the first example, there is one flash module 300 disposed at each side of the optical imaging system 200, respectively. In addition, the second housing 308 of the flash module 300 is a triangular housing so that the skin analyzer of the first example in the present disclosure has a cat's-face shaped appearance. Furthermore, the flash module 300 can be fixed on the base 100 through the second housing 308 so as to be integrated with the base 100. In details, the flash polarizer 302 is located between the flash lamp 304 and the imaging area A. Furthermore, the flash polarizer 302 and the imaging polarizer 204 can be disposed in a relatively orthogonal orientation with each other to allow the light to pass in a single direction.

Other elements of the skin analyzer in the first example, such as the circuit module 400, the computing module 500 and the display module 600, are mentioned above so that there is no further description herein.

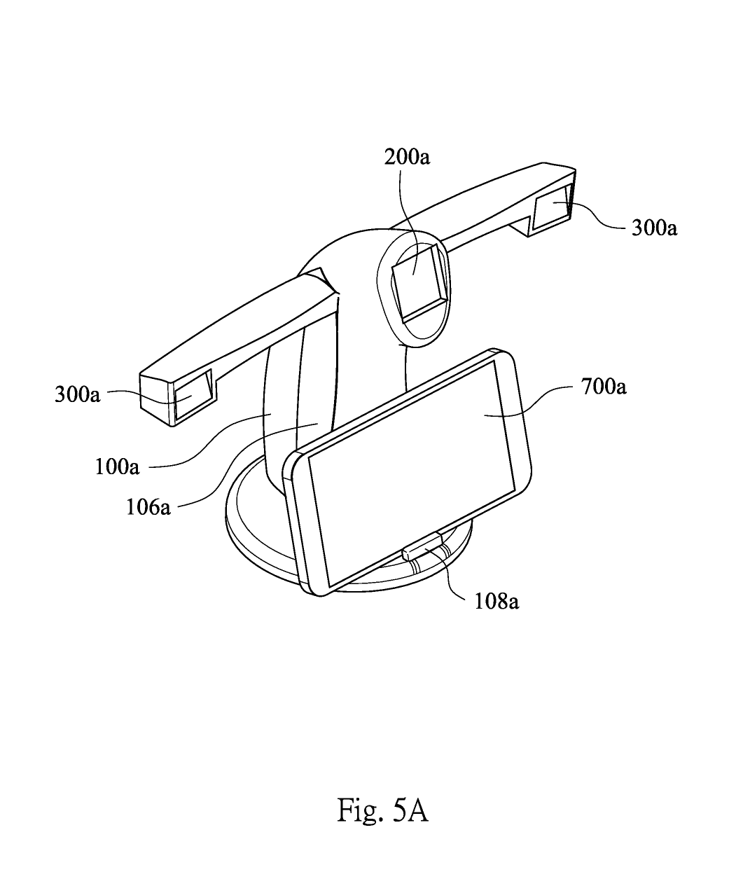

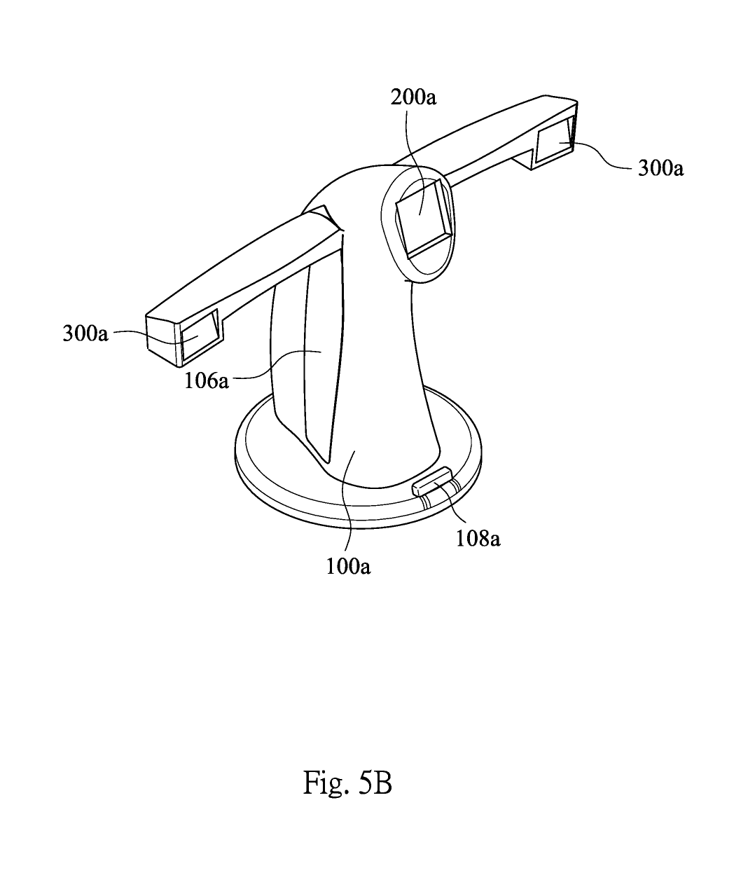

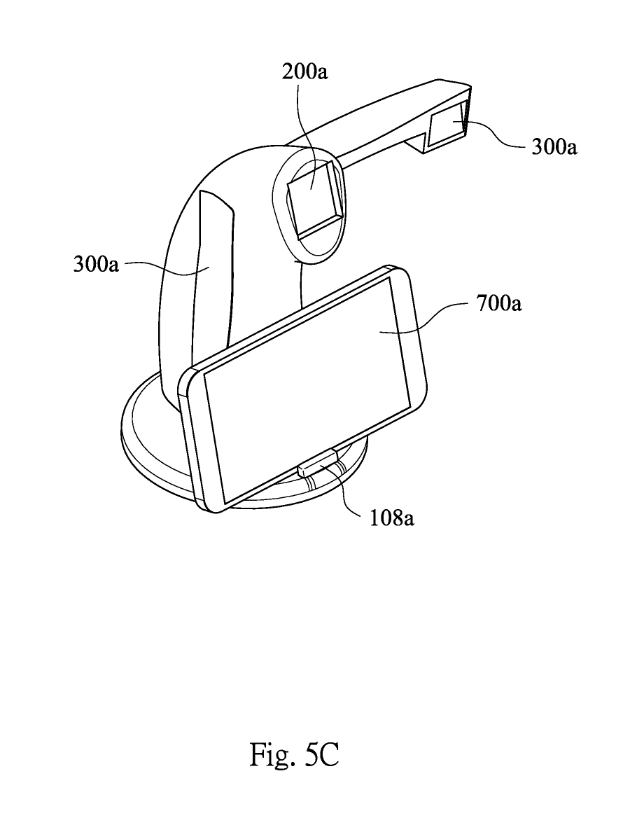

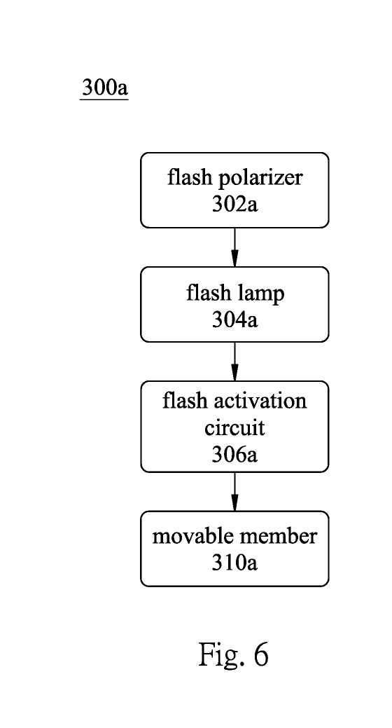

Please refer to FIGS. 5A, 5B, 5C and 6. FIG. 5A is a three dimensional view of a skin analyzer according to a second example of the present disclosure. FIG. 5B is a three dimensional view of the skin analyzer of FIG. 5A without the configuration of a portable device 700a. FIG. 5C is a schematic view of a flash module 300a in a folded position of the skin analyzer according to the second example of the present disclosure. FIG. 6 is a structural schematic view of the flash module 300a of the skin analyzer according to the second example of the present disclosure. As shown in FIG. 5A, the skin analyzer of the second example in the present disclosure includes a base 100a, an optical imaging system 200a, two flash modules 300a, a circuit module (not shown), a computing module (not shown) and a display module (not shown). The computing module and the display module of the skin analyzer herein are also built in the portable device 700a. In the second example, the configuration and the pathway of the signal transmission between the optical imaging system 200a, the flash modules 300a, the circuit module, the computing module and the display module are the same as the first example so that a description in this regard will not be provided again herein.

In the second example, the structure of the base 100a of the skin analyzer has a narrow top and a wide bottom so that an additional support stand for the base 100a is not required herein. In addition, a protrusion 108a is formed on the base 100a for fixing the portable device 700a thereon.

The base 100a has two second receiving grooves 106a. Each of the second receiving grooves 106a is disposed at each side of the base 100a corresponding to one of the flash modules 300a. As shown in FIG. 6, the second example is similar to the first example except for the flash modules 300a. Each of the flash modules 300a of the second example can include a movable member 310a disposed in the base 100a for moving the flash module 300a to an unfolded position (as shown in FIG. 5A and FIG. 5B) or a folded position (as shown in FIG. 5C). Furthermore, the portable device 700a can be detached as shown in FIG. 5B when the skin analyzer is not used. An operation of a user interface of the portable device 700a is then performed to switch on a flash activation circuit 306a of the flash module 300a. Thus, the movable member 310a drives the flash module 300a to move from the unfolded position to the folded position so as to be received in the second receiving groove 106a.

The conditions of the band-stop filter set utilized in the optical imaging system 200a of the skin analyzer according to the second example of the present disclosure are the same as the first example.

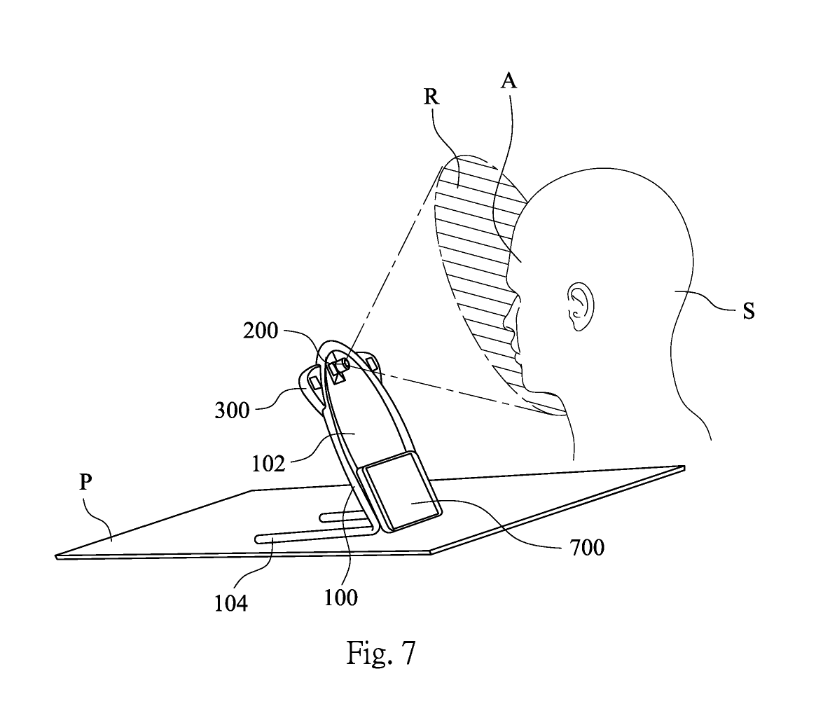

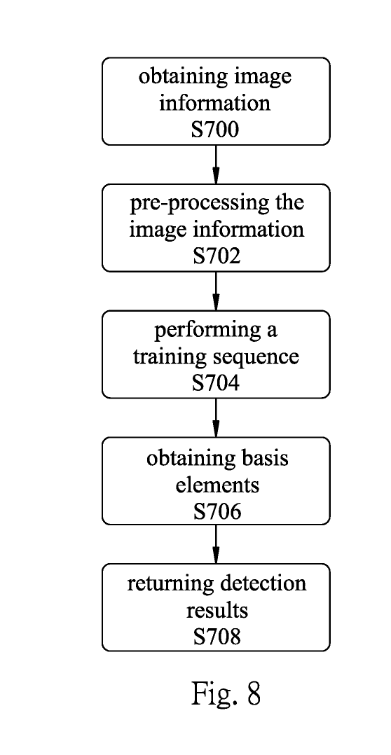

Each element of the skin analyzer in the present disclosure and the connection of these elements thereof have been illustrated as above. Subsequently, details of operating the skin analyzer in the first example and an analysis process are described and shown with FIGS. 7 and 8. FIG. 7 is schematic view showing an operation status of the skin analyzer according to the first example of the present disclosure. FIG. 8 is a flow chart of an image analysis process of the skin analyzer according to the first example of the present disclosure. The image analysis process includes Step S700, Step S702, Step S704, Step S706 and Step S708.

As shown in FIG. 7, the skin analyzer is placed on a surface plane P when a subject S accepts to detect a skin condition of his/her facial skin. An angle between the base 100 and the surface plane P can be adjusted through the stand 104 to allow the facial skin of the subject S (the imaging area A) to be positioned within the field of view of the optical imaging system 200. Then, the user interface of the portable device 700 is operated to allow the display module to send a control signal to the signal synchronization circuit of the circuit module for triggering the flash module 300 and the optical imaging system 200. The image of the imaging area A is captured through the imaging polarizer with the band-stop filter set, and then transmitted to the computing module through the data transmission module of the circuit module.

As shown in FIG. 8, the computing module obtains image information (Step S700) and then pre-processes the image information (Step S702). A training sequence is performed as shown in Step S704. Basis elements, such as an intensity and a distribution of signals of the first independent component and the second independent component, of the skin condition of the subject S are then obtained (Step 706) for evaluating quantitative indicators of the skin condition. A detection result will be returned to the display module (Step S708). Finally, the detection result and the image information of the imaging area A are shown by the display module.

In conclusion, the present disclosure utilizes the configuration of the band-stop filter set or the band-pass filter to suppress the overlapping signals of the B-G band and the G-R band. Thereby, the features of the image will not be hindered by the overlapping signals so as to improve the quality of the image after the conversion.

Although the present disclosure has been described in considerable detail with reference to certain embodiments thereof, there are other possible embodiments with different parameters. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A skin analyzer, comprising:
a base;
an optical imaging system disposed on the base facing toward an imaging area, wherein the optical imaging system comprises a band-stop filter set, an imaging polarizer and an imaging module;
at least a flash module disposed on at least one side of the optical imaging system, wherein the flash module comprises a flash polarizer, a flash lamp and a flash activation circuit;
a circuit module disposed in the base and connected electrically with the optical imaging system and the flash module, wherein the circuit module comprises a power control circuit, a data transmission circuit and a signal synchronization circuit;
a computing module having a signal transmitting connection with the circuit module; and
a display module having a signal transmitting connection with the computing module.

2. The skin analyzer of claim 1, wherein there is one flash module disposed at each side of the optical imaging system, respectively.

3. The skin analyzer of claim 1, wherein the band-stop filter set comprises three or less single-band-stop filters.

4. The skin analyzer of claim 1, wherein the imaging module comprises an imaging lens assembly and an image sensor.

5. The skin analyzer of claim 1, wherein each of the imaging polarizer and the flash polarizer is a linear polarizer.

6. The skin analyzer of claim 1, wherein the band-stop filter is a notch filter.

7. The skin analyzer of claim 1, wherein the flash module comprises a movable member for moving the flash module to an unfolded position or a folded position.

8. The skin analyzer of claim 1, wherein the data transmission circuit comprises a wireless transmission module.

9. The skin analyzer of claim 4, wherein a peak quantum efficiency of a red band of the image sensor is less than a peak quantum efficiency of a green band or a blue band of the image sensor.

10. The skin analyzer of claim 4, wherein a full width at half maximum of the band-stop filter set is less than 40 nm.

11. The skin analyzer of claim 1, wherein the band-stop filter set comprises a first band-stop filter and a second band-stop filter.

12. The skin analyzer of claim 11, wherein the first band-stop filter is a blue-green filter, the second band-stop filter is a green-red filter, an upper limit wavelength of a band-stop of the first band-stop filter is WL1, and a lower limit wavelength of a band-stop of the second band-stop filter is WL2, the following condition is satisfied:
70 nm<WL2−WL1<100 nm.

13. The skin analyzer of claim 1, wherein the flash polarizer and the imaging polarizer are disposed in a relatively orthogonal orientation with each other.

14. The skin analyzer of claim 4, wherein the band-stop filter set is disposed between the imaging polarizer and the image sensor.

15. The skin analyzer of claim 4, wherein the imaging polarizer is disposed between the band-stop filter set and the image sensor.

16. The skin analyzer of claim 1, wherein the flash polarizer is disposed between the flash lamp and the imaging area.

17. A skin analyzer, comprising:
a base;
an optical imaging system disposed on the base and comprising a band-pass filter, an imaging polarizer and an imaging module;
at least a flash module disposed on at least one side of the optical imaging system, wherein the flash module comprises a flash polarizer, a flash lamp and a flash activation circuit;
a circuit module disposed in the base and connected electrically with the optical imaging system and the flash module, wherein the circuit module comprises a power control circuit, a data transmission circuit and a signal synchronization circuit;
a computing module connected electrically to the circuit module; and
a display module connected electrically to the computing module.

18. A skin analyzer, comprising:
a base;
an optical imaging system disposed on the base facing toward an imaging area, wherein the optical imaging system comprises an imaging module;
at least a flash module disposed on at least one side of the optical imaging system, wherein the flash module comprises a flash lamp and a flash activation circuit;
a circuit module disposed in the base and connected electrically with the optical imaging system and the flash module, wherein the circuit module comprises a power control circuit, a data transmission circuit and a signal synchronization circuit;
a computing module having a signal transmitting connection with the circuit module; and
a display module having a signal transmitting connection with the computing module, wherein the display module is a portable device disposed on the base.

19. The skin analyzer of claim 18, wherein the base comprises a protrusion for fixing the portable device.

20. The skin analyzer of claim 18, wherein the portable device has a display and the display faces toward the same direction with the optical imaging system.

21. The skin analyzer of claim 18, wherein the data transmission circuit comprises a wireless transmission module.

22. The skin analyzer of claim 18, wherein there is one flash module disposed at each side of the optical imaging system, respectively.

23. The skin analyzer of claim 18, wherein the optical imaging system further comprises an imaging polarizer, the flash module further comprises a flash polarizer, and the flash polarizer and the imaging polarizer are disposed in a relatively orthogonal orientation with each other.

24. The skin analyzer of claim 18, wherein the optical imaging system further comprises a band-stop filter set.

25. The skin analyzer of claim 24, wherein the band-stop filter set comprises three or less single-band-stop filters.

26. The skin analyzer of claim 24, wherein a full width at half maximum of the band-stop filter set is less than 40 nm.

27. The skin analyzer of claim 24, wherein the band-stop filter set comprises a first band-stop filter and a second band-stop filter, the first band-stop filter is a blue-green filter, the second band-stop filter is a green-red filter, an upper limit wavelength of a band-stop of the first band-stop filter is WL1, a lower limit wavelength of a band-stop of the second band-stop filter is WL2, and the following condition is satisfied:
70 nm<WL2−WL1<100 nm.

28. The skin analyzer of claim 24, wherein the optical imaging system further comprises an imaging polarizer and the band-stop filter set is disposed between the imaging polarizer and an image sensor.

29. The skin analyzer of claim 24, wherein the optical imaging system further comprises an imaging polarizer and the imaging polarizer is disposed between the band-stop filter set and an image sensor.
